(19) United States
(12) Patent Application Publication
(10) Pub. No.: US 2016/0131132 A1
(43) Pub. Date: May 12, 2016

(54) Piston Seal and Pump Including Same

(71) Applicant: Caterpillar Inc., Peoria, IL (US)

(72) Inventors: Alan R. Stockner, Metamora, IL (US); Dana R. Coldren, Secor, IL (US)

(73) Assignee: Caterpillar Inc., Peoria, IL (US)

(21) Appl. No.: 14/538,269

(22) Filed: Nov. 11, 2014

(51) Int. Cl. F04B 53/14; F16J 9/26; F16J 9/20; F16J 9/06

(52) U.S. Cl. CPC F04B 53/143; F16J 9/06; F16J 9/26; F16J 9/20

(57) ABSTRACT

A seal for a piston of a positive displacement pump includes an annular seal element, a radially outer surface of the annular seal element defining a longitudinal axis, and an annular energizer disposed between the annular seal element and the longitudinal axis along a radial direction. The annular energizer has a resilience along the radial direction to bias the annular seal element away from the longitudinal axis along the radial direction, the radial direction being perpendicular to the longitudinal axis. The radially outer surface of the annular seal element defines at least one circumferential groove about the annular seal element, and a concavity of the at least one circumferential groove faces away from the longitudinal axis along the radial direction

### TECHNICAL FIELD

This patent disclosure relates generally to piston pumps and, more particularly, to a piston seal for a piston pump.

### BACKGROUND

Positive displacement pumps are known for pressurizing a fluid, effecting a fluid flow, or combinations thereof. Positive displacement pumps may trap a fixed mass of fluid in a pumping chamber and then perform work on the fixed mass of fluid by deforming or displacing a boundary of the pumping chamber. Reciprocating positive displacement pumps include plunger pumps, piston pumps, and diaphragm pumps, for example. Piston pumps may include a seal disposed about a circumference of the piston and disposed in sliding contact with a bore surrounding the piston.

U.S. Pat. No. 6,502,826 (hereinafter “the '826 patent”) describes a piston seal suitable for use in high-pressure hydraulic cylinders. The piston seal includes a split rigid seal ring adapted for sealing engagement with an inner wall of a hydraulic cylinder, an elastomeric energizer ring, and a pair of wedge rings shaped and fitted to fill annular cavities defined between the elastomeric energizer ring and a seal groove in the piston.

Although the piston seal described in the '826 patent may be advantageous for some applications, other seal configurations are desired to promote seal performance, seal life, or both, in other applications. Accordingly, aspects of the disclosure address the aforementioned problems and/or other problems in the art.

### SUMMARY

According to an aspect of the disclosure, a seal for a piston of a positive displacement pump includes an annular seal element, a radially outer surface of the annular seal element defining a longitudinal axis, and an annular energizer disposed between the annular seal element and the longitudinal axis along a radial direction. The annular energizer has a resilience along the radial direction to bias the annular seal element away from the longitudinal axis along the radial direction, the radial direction being perpendicular to the longitudinal axis. The radially outer surface of the annular seal element defines at least one circumferential groove about the annular seal element, and a concavity of the at least one circumferential groove faces away from the longitudinal axis along the radial direction.

According to another aspect of the disclosure, a seal for a piston of a positive displacement pump includes an annular seal element, a radially outer surface of the annular seal element defining a longitudinal axis, an annular energizer disposed between the annular seal element and the longitudinal axis along a radial direction, and a carrier ring disposed between the annular energizer and the longitudinal axis along the radial direction. The annular energizer has a resilience along the radial direction to bias the annular seal element away from the longitudinal axis along the radial direction, where the radial direction is perpendicular to the longitudinal axis. The carrier ring includes an annular base, a first flange extending radially from the annular base, and a second flange extending radially from the annular base, the second flange being spaced apart from the first flange along an axial direction, where the axial direction is parallel to the longitudinal axis. The annular seal element is at least partly disposed between the first flange and the second flange of the carrier ring along the axial direction.

According to another aspect of the disclosure, a positive displacement pump includes a housing defining a bore therein, a piston disposed within the bore and configured for reciprocating translation therein, and a seal disposed about a circumference of the piston. The seal includes an annular seal element, a radially outer surface of the annular seal element defining a longitudinal axis, the radially outer surface of the annular seal element being in sliding contact with the bore, and an annular energizer disposed between the annular seal element and the longitudinal axis along a radial direction. The annular energizer has a resilience along the radial direction to bias the annular seal element away from the longitudinal axis along the radial direction, where the radial direction being perpendicular to the longitudinal axis. The radially outer surface of the annular seal element defines at least one circumferential groove about the annular seal element, and a concavity of the at least one circumferential groove faces away from the longitudinal axis along the radial direction.

According to an aspect of the disclosure, a piston assembly includes a piston, and a seal disposed about a circumference of the piston. The seal includes an annular seal element, a radially outer surface of the annular seal element defining a longitudinal axis, and an annular energizer disposed between the annular seal element and the longitudinal axis along a radial direction. The annular energizer has a resilience along the radial direction to bias the annular seal element away from the longitudinal axis along the radial direction, the radial direction being perpendicular to the longitudinal axis. The radially outer surface of the annular seal element defines at least one circumferential groove about the annular seal element, and a concavity of the at least one circumferential groove faces away from the longitudinal axis along the radial direction.

According to another aspect of the disclosure, a piston assembly includes a piston, and a seal disposed about a circumference of the piston. The seal includes an annular seal element, a radially outer surface of the annular seal element defining a longitudinal axis, an annular energizer disposed between the annular seal element and the longitudinal axis along a radial direction, and a carrier ring disposed between the annular energizer and the longitudinal axis along the radial direction. The annular energizer has a resilience along the radial direction to bias the annular seal element away from the longitudinal axis along the radial direction, where the radial direction is perpendicular to the longitudinal axis. The carrier ring includes an annular base, a first flange extending radially from the annular base, and a second flange extending radially from the annular base, the second flange being spaced apart from the first flange along an axial direction, where the axial direction is parallel to the longitudinal axis. The annular seal element is at least partly disposed between the first flange and the second flange of the carrier ring along the axial direction.

According to another aspect of the disclosure, a positive displacement pump includes a housing defining a bore therein, a piston disposed within the bore and configured for reciprocating translation therein, and a seal disposed about a circumference of the piston. The seal includes an annular seal element, a radially outer surface of the annular seal element defining a longitudinal axis, an annular energizer disposed between the annular seal element and the longitudinal axis along a radial direction, and a carrier ring disposed between the annular energizer and the longitudinal axis along the radial direction. The annular energizer has a resilience along the radial direction to bias the annular seal element away from the longitudinal axis along the radial direction, where the radial direction is perpendicular to the longitudinal axis. The carrier ring includes an annular base, a first flange extending radially from the annular base, and a second flange extending radially from the annular base, the second flange being spaced apart from the first flange along an axial direction, where the axial direction is parallel to the longitudinal axis. The annular seal element is at least partly disposed between the first flange and the second flange of the carrier ring along the axial direction.

### BRIEF DESCRIPTION OF THE DRAWINGS

FIG. 1 illustrates a machine, according to an aspect of the disclosure.

FIG. 2 shows a reciprocating piston pump, according to an aspect of the disclosure.

FIG. 3 shows a top view of a piston, according to an aspect of the disclosure.

FIG. 4 shows a cross sectional view of the pump highlighted as Detail A in FIG. 2, according to an aspect of the disclosure.

FIG. 5 shows a cross sectional view of the pump highlighted as Detail A in FIG. 2, according to an aspect of the disclosure.

### DETAILED DESCRIPTION

Aspects of the disclosure will now be described in detail with reference to the drawings, wherein like reference numbers refer to like elements throughout, unless specified otherwise.

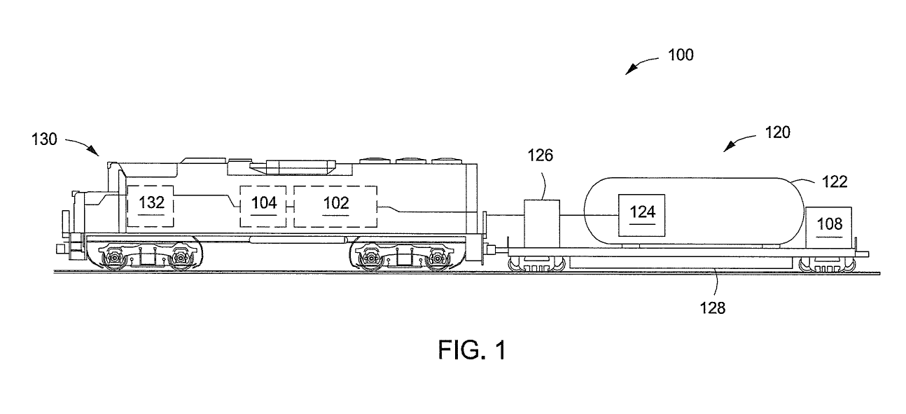

FIG. 1 illustrates a machine 100, according to an aspect of the disclosure. The machine can be a railroad vehicle, an “over-the-road” vehicle such as a truck used in transportation, an off-road vehicle, or may be any other type of machine that performs an operation associated with an industry such as mining, construction, farming, transportation, or any other industry known in the art. For example, the machine may be an off-highway truck, a railroad locomotive, a marine vehicle or machine, an earth-moving machine, such as a wheel loader, an excavator, a dump truck, a backhoe, a motor grader, a material handler, or the like. The term “machine” can also refer to stationary equipment, such as a generator that is driven by an internal combustion engine to generate electricity. The specific machine 100 illustrated in FIG. 1 is a railroad locomotive.

The machine 100 includes an internal combustion (IC) engine 102 operatively coupled to a controller 104. The IC engine 102 may be a reciprocating piston engine, such as a compression ignition engine or a spark ignition engine, a turbomachine such as a gas turbine, combinations thereof, or any other internal combustion engine known in the art.

The IC engine 102 may receive fuel from one or more fuel supply systems 120, including, but not limited to, a liquid fuel supply system, a gaseous fuel supply system, or combinations thereof. Liquid fuel provided by a liquid fuel supply system may include distillate diesel, biodiesel, dimethyl ether, seed oils, gasoline, ethanol, liquefied petroleum gas (LPG), liquefied natural gas (LNG), combinations thereof, or any other combustible liquid fuel known in the art. Gaseous fuel provided by a gaseous fuel supply system may include gaseous propane, hydrogen, methane, ethane, butane, natural gas, combinations thereof, or any other combustible gaseous fuel known in the art. The IC engine 102 may be configured to simultaneously burn mixtures of fuel from two or more fuel supply systems 120 with an oxidizer.

It will be appreciated that some fuels, such as LNG, may be stored in a liquid state and supplied to the engine 102 in a liquid state, a gaseous state, or combinations thereof. It will be further appreciated that some liquid fuels may be stored at cryogenic temperatures that are much lower than an ambient temperature of the machine 100. According to an aspect of the disclosure, cryogenic temperatures are temperatures less than about −215 degrees Fahrenheit.

The fuel source 120 includes a supply tank 122 that is fluidly coupled to the IC engine 102. The fluid coupling between the supply tank 122 and the engine 102 may include a low-pressure transfer pump 124 (e.g., 150-300 psi), a fluid conditioning system 126, or combinations thereof. The fluid conditioning system 126 may include a high-pressure pump (e.g., 5000-6000 psi), a filter, a heat exchanger, sensors, control valves, actuators, accumulators, combinations thereof, or any other structures known to benefit the conditioning of fuel for the IC engine 102. The fuel supply system 120 may also be operatively coupled to the controller 104 for control thereof.

Although the specific fuel supply system 120 illustrated in FIG. 1 is supported or carried by a railroad tender car 128, it will be appreciated that the fuel supply system may be incorporated into other machines in other ways depending on the needs of the particular application.

The supply tank 122 is configured to store a fluid in the fuel supply system 120. Unless specified otherwise, the term “fluid” is used herein to describe gases, liquids, slurries, combinations thereof, or other similar matter that tends to flow in response to applied sheer stress. The first fluid may be a gaseous combustible fuel or a liquid combustible fuel suitable for fueling the IC engine 102, for example. However, it will be appreciated that aspects of the present disclosure may be advantageously applied to pump systems for non-combustible fluids such as water, air, liquid or gaseous nitrogen, or other non-combustible fluids known in the art. According to an aspect of the disclosure, the supply tank 122 is a cryogenic supply tank for storage of LNG, and includes a cryogenic system 108 in thermal communication with the supply tank 122 for controlling a temperature of the LNG stored within the supply tank 122.

The machine 100 may include an operator cab 130 that includes one or more control input devices 132 that are operatively coupled to the controller 104. The control input devices 132 may include manual control input devices configured to communicate manual control inputs from an operator in the cab 130 to the controller 104; automatic control input devices such as open-loop controllers, closed-loop controllers, or programmable logic controllers, for example; remote control input devices such as wired or wireless telemetry devices; combinations thereof; or any other control input device known in the art.

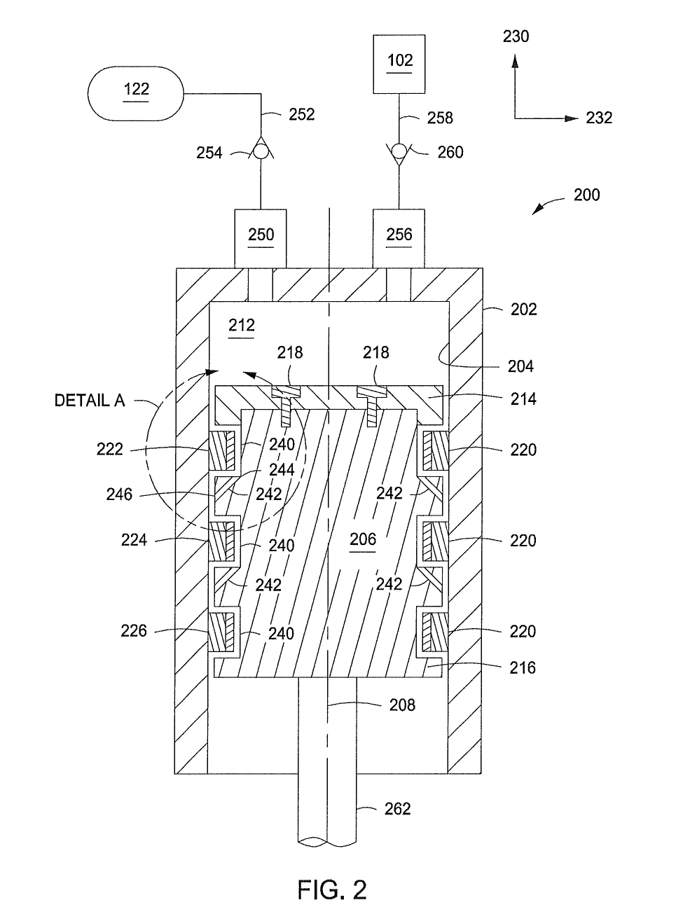

FIG. 2 shows a reciprocating piston pump 200, according to an aspect of the disclosure. The pump 200 may compose a portion of the low-pressure transfer pump 124 (see FIG. 1), a high-pressure pump within the fluid conditioning system 126 (see FIG. 1), or any other system known in the art to include a reciprocating piston pump. The pump 200 includes a housing 202 defining an internal bore 204 therein, and a piston 206 disposed within the internal bore 204. The piston 206 is configured for reciprocating motion relative to the housing 202 along a longitudinal axis 208 of the piston 206, and the piston 206 and the bore 204 at least partly define a pumping chamber 212 within the housing 202.

The piston 206 may optionally include a piston cap 214 fastened to a piston body 216, where the piston cap 214 faces and at least partly defines the pumping chamber 212. The piston cap 214 may be fastened to the piston body 216 by threaded fasteners, rivets, interference fit therebetween, welding, brazing, or any other fastening structure known in the art. As shown in FIG. 2, the piston cap 214 is fastened to the piston body 216 via one or more machine screws 218.

The piston 206 includes one or more seals 220 disposed about a circumference of the piston 206, and configured for sliding and sealing engagement with the internal bore 204. As illustrated in FIG. 2, the one or more seals 220 includes a first seal 222, a second seal 224, and a third seal 226. The first seal 222 is disposed closest to the pumping chamber 212 along an axial direction 230 that is parallel to the longitudinal axis 208. The third seal 226 is disposed furthest from the pumping chamber 212 along the axial direction 230, and the second seal 224 is disposed between the first seal 222 and the third seal 226 along the axial direction 230.

A radial direction 232 extends normal or perpendicular to the axial direction 230, and the section in FIG. 2 is taken along a plane in the axial direction 230 and the radial direction 232, which includes the longitudinal axis 208.

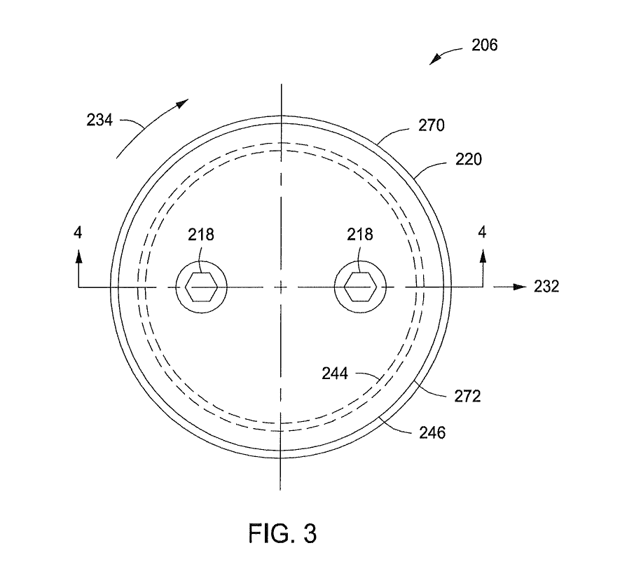

Any or all of the one or more seals 220 may be at least partially disposed within lands 240 defined by the piston 206. The lands 240 may be grooves extending around the piston 206 in a circumferential direction 234 (see FIG. 3) and extending into the circumference of the piston 206 along the radial direction 232 toward the longitudinal axis 208. The piston 206 may also define leakage channels 242 extending from near a trough 244 of one land 240 to a peak 246 of an adjacent land 240, where the trough 244 of the one land 240 is closer to the pumping chamber 212 than the peak 246 of the adjacent land 240.

The pumping chamber 212 may be in fluid communication with the supply tank 122 via an inlet port 250 and an inlet conduit 252. The inlet conduit 252 may include an inlet check valve 254, which allows flow only in a direction from the supply tank 122 toward the inlet port 250. The pumping chamber 212 may also be in fluid communication with the IC engine 102, or any other apparatus that could benefit from receipt of a pressurized fluid, via an outlet port 256 and an outlet conduit 258. The outlet conduit 258 may include an outlet check valve 260, which allows flow only in a direction from the outlet port 256 toward the outlet check valve 260.

The piston 206 is operably coupled to a motor (not shown) via a rod or shaft 262 for transmission of mechanical power therebetween. A volume of the pumping chamber 212 varies with translating motion of the pump piston 206 relative to the pump housing 202. During a retraction stroke, the volume of the pumping chamber 212 increases, thereby drawing fluid into the pumping chamber 212 from the supply tank 122 via the inlet check valve 254. During a pumping stroke, the volume of the pumping chamber 212 decreases, thereby discharging fluid out of the pumping chamber 212 via the outlet check valve 260. Although only one pump bore 204 and only one pump piston 206 are shown in FIG. 2, it will be appreciated that the pump 200 may have any number of pistons and bores to suit the particular application.

The motor coupled to the shaft 262 may take the form of a linear motor, a rotary shaft motor having an offset crank journal pivotably coupled to a reciprocating connecting rod, or any other motor-linkage system known in the art for effecting reciprocating motion. The motor may be driven by hydraulic power, electrical power, pneumatic power, combinations thereof, or any other power source known in the art for driving a motor.

FIG. 3 shows a top view of a piston 206, according to an aspect of the disclosure. The view of the piston 206 in FIG. 3 is from the vantage of the pumping chamber 212 looking toward the shaft 262. The trough 244 of a land 240 is shown in phantom view, and an outer radial edge 270 of a seal 220 is shown extending beyond a peak 246 of a land 240. Section line 4-4 lies in a plane defined by the radial direction 232 and the axial direction 230 (see FIG. 2) and includes the longitudinal axis 208 (see FIG. 2).

According to an aspect of the disclosure the outer radial edge 270 of a seal 220 is centered on the longitudinal axis 208. According to another aspect of the disclosure, an outer radial edge 272 of the piston 206 is centered on the longitudinal axis 208. According to another aspect of the disclosure, the bore 204 (see FIG. 2) is centered on the longitudinal axis 208.

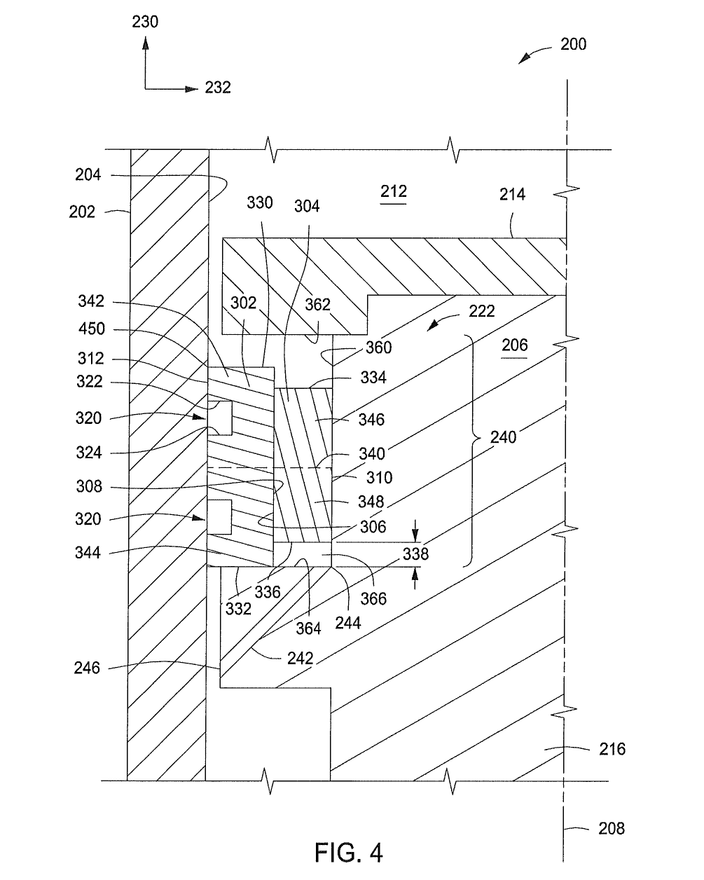

FIG. 4 shows a cross sectional view of the pump 200 highlighted as Detail A in FIG. 2, according to an aspect of the disclosure. As shown in FIG. 4, the first seal 222 includes a seal element 302 and an energizer 304 disposed between the longitudinal axis 208 and the seal element 302 along the radial direction 232, where the energizer 304 bears on the seal element 302. According to an aspect of the disclosure, the seal element 302 is an annular seal element that extends around the piston 206 in the circumferential direction 234 (see FIG. 3). According to another aspect of the disclosure, the outer surface of the seal element 302 may be substantially defined by a surface of revolution about the longitudinal axis 208. According to another aspect of the disclosure, the energizer 304 is an annular energizer that extends around the piston 206 in the circumferential direction 234 (see FIG. 3). According to another aspect of the disclosure, the outer surface of the energizer 304 may be substantially defined by a surface of revolution about the longitudinal axis 208.

The energizer 304 has a resilience along the radial direction 232 to bias the seal element 302 away from the longitudinal axis 208, and therefore toward the bore 204 of the housing 202, along the radial direction 232. A radially outer surface 306 of the energizer 304 may bear on a radially inner surface 308 of the seal element 302 through direct contact therebetween. However, it will be appreciated that the energizer 304 may still bear on the seal element 302 through an intermediate structure, such that the radially outer surface 306 of the energizer 304 is not in direct contact with the radially inner surface 308 of the seal element 302.

A radially inner surface 310 of the energizer 304 bears on the piston 206, and a radially outer surface 312 of the seal element 302 engages the bore 204 in sliding contact. According to an aspect of the disclosure, portions of the radially outer surface 312 of the seal element 302 that engage the bore 204 in sliding contact are substantially parallel to the longitudinal axis 208.

A distance along the radial direction 232 from the radially inner surface 310 of the energizer 304 to the radially outer surface of the energizer 304 may define a radial thickness of the energizer 304. Likewise, a distance along the radial direction 232 from the radially inner surface 308 of the seal element 302 to the radially outer surface 312 of the seal element 302 may define a radial thickness of the seal element 302.

A distance along the axial direction 230 from a proximal axial surface 330 to a distal axial surface 332 of the seal element 302 may define an axial length of the seal element 302. Likewise, a distance along the axial direction 230 from a proximal axial surface 334 to a distal axial surface 336 of the energizer 304 may define an axial length of the energizer 304. According to an aspect of the disclosure, the axial length of the energizer 304 is less than the axial length of the seal element 302. According to another aspect of the disclosure, the axial length of the energizer 304 is less than the axial length of the seal element 302, and the axial length of the energizer 304 is substantially centered along the axial length of the seal element 302 along the axial direction 230. According to another aspect of the disclosure, the distal axial surface 336 of the energizer 304 is offset from the distal axial surface 332 of the seal element 302 toward the pumping chamber 212 along the axial direction 230 by an offset distance 338.

The radially outer surface 312 of the seal element 302 may define at least one circumferential groove 320. The circumferential groove 320 may be defined between a proximal axial wall 322 and a distal axial wall 324 of the radially outer surface 312 of the seal element 302, such that a concavity of the circumferential groove 320 faces away from the longitudinal axis 208 along the radial direction 232. The seal element 302 illustrated in FIG. 4 includes two circumferential grooves 320, however it will be appreciated that any number of circumferential grooves 320, greater than or equal to zero, may be employed to suit a particular application.

As illustrated in FIG. 4, the circumferential grooves 320 have a rectangular cross section in the plane defined by the axial direction 230 and the radial direction 232, and including the longitudinal axis 208. However, it will be appreciated that the circumferential grooves 320 may have any cross section to suit a particular application, including a semi-circular cross section, an elliptical cross section, a triangular cross section, a parabolic cross section, a rhomboid cross section, combinations thereof, or any other groove cross section known in the art.

The seal element 302 may be a unitary seal element free from any breaks or splits about the circumference of the seal element 302, and therefore continuous about the circumference of the seal element 302. Alternatively, the seal element 302 may be a split seal element that includes a break or split at a circumferential location or over a circumferential sector about the seal element 302. Alternatively or additionally, the seal element 302 may be split in a plane 340 defined at least by the radial direction 232 and the circumferential direction 234 (see FIG. 3), such that the seal element 302 includes a proximal portion 342, and a distal portion 344 that is distinct from the proximal portion 342. According to an aspect of the disclosure, each of the proximal portion 342 and the distal portion 344 of the seal element 302 may define a circumferential groove 320.

The energizer 304 may be a unitary energizer free from any breaks or splits about the circumference of the energizer 304. Alternatively, the energizer 304 may be a split energizer that includes a break or split at a circumferential location or over a circumferential sector about the energizer 304. Alternatively or additionally, the energizer 304 may be split along the plane 340 defined at least by the radial direction 232 and the circumferential direction 234, such that the energizer 304 includes a proximal portion 346, and a distal portion 348 that is distinct from the proximal portion 346. It will be appreciated that the plane 340 may also have a component along the axial direction 230, be a surface of revolution about the longitudinal axis 208, or any other break surface that could define distinct proximal and distal portions of the seal element 302 or the energizer 304 along the axial direction 230.

According to an aspect of the disclosure, the proximal axial surface 330 of the seal element 302, the distal axial surface 332 of the seal element 302, or both, may be substantially parallel to the radial direction 232. According to another aspect of the disclosure, the proximal axial surface 334 of the energizer 304, the distal axial surface 336 of the energizer 304, or both, may be substantially parallel to the radial direction 232.

The land 240 that receives the first seal 222 may include a radial wall 360, a proximal axial wall 362, and a distal axial wall 364. The radial wall 360 faces away from the longitudinal axis 208 along the radial direction 232. The proximal axial wall 362 and the distal axial wall 364 at least partly face one another along the axial direction 230. According to an aspect of the disclosure, the piston cap 214 at least partly defines the proximal axial wall 362.

The seal element 302 may be free to slide within the land 240 during operation of the pump 200. For example, as shown in FIG. 4, during a pumping stroke, the distal axial surface 332 of the seal element 302 may bear against the distal axial wall 364 of the land 240, and the proximal axial surface 330 of the seal element 302 may be free from bearing on the proximal axial wall 362 of the land 240. Conversely, during a retraction stroke, the seal element 302 may slide within the land 240 along the axial direction 230 until the proximal axial surface 330 of the seal element 302 bears against the proximal axial wall 362 of the land 240, and the distal axial surface 332 of the seal element 302 may be free from bearing against the distal axial wall 364 of the land 240.

The radially inner surface 308 of the seal element 302, the distal axial surface 336 of the energizer 304, and the distal axial wall 364 of the land 240 may define a leakage chamber 366. The leakage chamber 366 may be in fluid communication with a corresponding leakage channel 242.

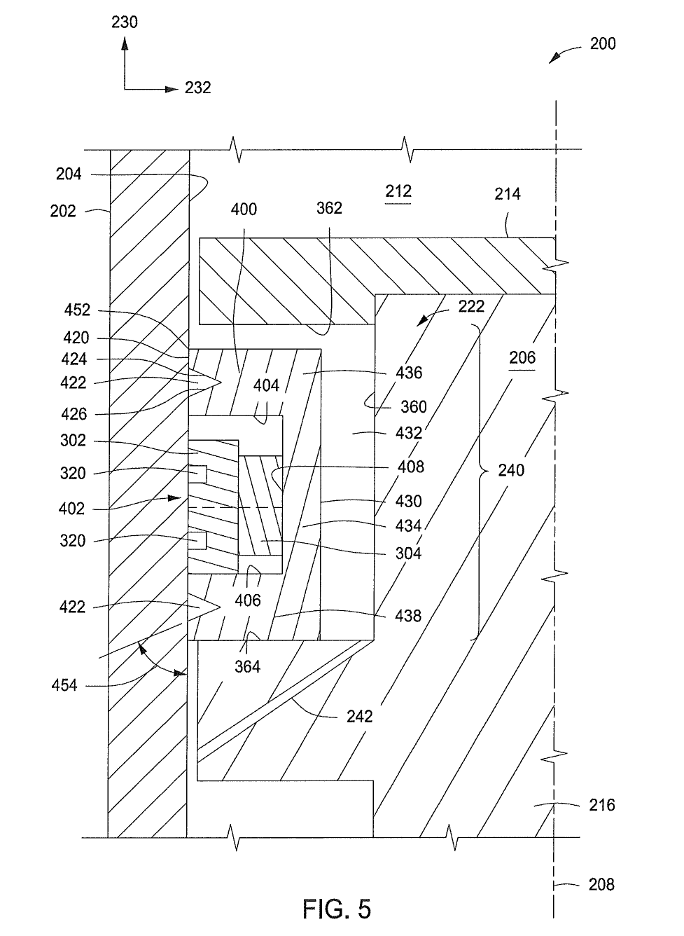

FIG. 5 shows a cross sectional view of the pump 200 highlighted as Detail A in FIG. 2, according to an aspect of the disclosure. Similar to the aspect shown in FIG. 4, the aspect shown in FIG. 5 includes a first seal 222 disposed at least partly within a land 240 defined by the piston 206. However, the first seal 222 illustrated in FIG. 5 further includes a carrier ring 400. The carrier ring 400 may include an annular base 434, a proximal flange 436 extending from the annular base 434 along the radial direction 232, and a distal flange 438 extending from the annular base 434 along the radial direction 232. The proximal flange 436 is spaced apart from the distal flange 438 along the axial direction 230.

The carrier ring 400 defines a carrier land 402, and the seal element 302 and the energizer 304 are disposed at least partly within the carrier land 402. The carrier land 402 may be defined at least partly by an inner proximal axial wall 404, an inner distal axial wall 406, and an inner radial wall 408 of the carrier ring 400. The inner proximal axial wall 404 of the carrier ring 400 may compose at least a portion of the proximal flange 436, and the inner distal axial wall 406 of the carrier ring 400 may compose at least a portion of the distal flange 438. The inner radial wall 408 of the carrier ring 400 may compose at least a portion of the annular base 434. The energizer 304 bears on the inner radial wall 408 of the carrier ring 400, and the seal element 302 bears on the bore 204 in sliding engagement. It will be appreciated that the energizer 304 and the seal element 302 illustrated in FIG. 5 may include any of the features or structures described for these elements as discussed above regarding FIG. 4.

A radially outer surface 420 of the carrier ring 400 may also bear against the bore 204 in sliding engagement. The radially outer surface 420 of the carrier ring 400 may define at least one circumferential groove 422. The circumferential groove 422 may be defined between a proximal wall 424 and a distal wall 426 along the radially outer surface 420 of the carrier ring 400, such that a concavity of the circumferential groove 422 faces away from the longitudinal axis 208 along the radial direction 232. The carrier ring 400 illustrated in FIG. 5 includes two circumferential grooves 422, however it will be appreciated that any number of circumferential grooves 422, greater than or equal to zero, may be employed to suit a particular application. The proximal flange 436 of the carrier ring 400 may define a circumferential groove 422, and the distal flange 438 of the carrier ring 400 may define another circumferential groove 422.

According to an aspect of the disclosure, an angle 454 defined by either the proximal wall 424 or the distal wall 426 of a circumferential groove 422 and the cylinder bore 204, at the intersection of the proximal wall 424 or the distal wall 426 with the cylinder bore 204, is substantially 90 degrees. According to another aspect of the disclosure, the angle 454 defined by either the proximal wall 424 or the distal wall 426 of a circumferential groove 422 and the cylinder bore 204, at the intersection of the proximal wall 424 or the distal wall 426 with the cylinder bore 204, is less than 90 degrees.

According to an aspect of the disclosure, the first seal 222 includes one or more circumferential grooves 320 defined by the seal element 302 and one or more circumferential grooves 422 defined by the carrier ring 400. According to another aspect of the disclosure, the first seal 222 includes one or more circumferential grooves 320 defined by the seal element 302 but does not include any circumferential grooves 422 defined by the carrier ring. According to another aspect of the disclosure, the first seal 222 includes one or more circumferential grooves 422 defined by the carrier ring but does not include any circumferential grooves 320 defined by the seal element 302.

As illustrated in FIG. 5, the circumferential grooves 422 have a triangular cross section in the plane defined by the axial direction 230 and the radial direction 232, and including the longitudinal axis 208. However, it will be appreciated that the circumferential grooves 320 may have any cross section to suit a particular application, including a semi-circular cross section, an elliptical cross section, a rectangular cross section, a parabolic cross section, a rhomboid cross section, combinations thereof, or any other groove cross section known in the art.

The carrier ring 400 may be a unitary carrier ring free from any breaks or splits about the circumference of the carrier ring 400, and therefore continuous about the circumference of the carrier ring 400. Alternatively, the carrier ring 400 may be a split carrier ring that includes a break or split at a circumferential location or over a circumferential sector about the carrier ring 400. According to an aspect of the disclosure, an outer surface of the carrier ring 400 may be substantially defined by a surface of revolution about the longitudinal axis 208.

According to an aspect of the disclosure, a radially inner surface 430 faces but does not contact the radial wall 360 of the land 240. Further the radially inner surface 430 of the carrier ring 400 and the radial wall 360 of the land 240 may at least partly define a leakage chamber 432. The leakage chamber 432 is in fluid communication with a corresponding leakage channel 242.

### INDUSTRIAL APPLICABILITY

The present disclosure is applicable to piston pumps and, more particularly, to a piston seal for a piston pump.

Piston seal life in a reciprocating pump may be a function of the amount and nature of solid particulates in the fluid being pumped, such that increases in the size, number density, or hardness of the particulates, for example, may decrease seal life. Particulates may decrease seal life by eroding material away from the seal, hardening the seal by embedding in the seal material, or combinations thereof, for example. Cryogenic fuel pumping applications may be particularly sensitive to particulates in the pumped fluid, in part, because the pumped cryogenic fuel may offer less lubricity than other fluids.

The higher the sealing performance demanded of a seal, the more sensitive seal life may be to particulates in the pumped fluid. In some applications, the sealing performance may be characterized as the product of a bearing pressure of the seal against the cylinder bore (P) and the velocity of the seal relative to the cylinder bore (V), the so-called PV parameter. Accordingly, higher pressure pumping applications may impose higher PV performance demands on a seal, and may result in higher sensitivity to particulates.

A piston seal may bear against a corresponding cylinder bore with a force generated by resilience of the seal structure (i.e., structure balance), a fluid pressure acting against the piston seal toward the cylinder bore (i.e., pressure balance), or a combination thereof. Conventional piston seals are not pressure balanced, and therefore may exhibit higher wear rates than pressure balanced seals, or seals using combined structure and pressure balance.

Referring to FIG. 2, aspects of the disclosure provide a multi-seal arrangement for a piston 206 of a reciprocating piston pump, to address the above-noted sensitivities regarding seal wear, cylinder bore wear, or both. For example, aspects of the disclosure divide the sealing burden among multiple seals 220, such that the first seal 222, or leading seal closest to the pumping chamber 212, provides a particle scraping function, a particle grinding function, a particle storing function, or combinations thereof, but may perhaps carry a lower or higher proportion of the overall sealing demand than the other seal stages. The first seal 222 may provide a cleaner operating environment for the other seals 220 in the multi-stage sealing arrangement, which may in turn allow the application of higher-performing seals in the other seal stages 220, which may be more sensitive to particulates than the first seal 222. In turn, a multiple-stage sealing arrangement using different sealing structures in any two of the stages may provide seal life advantages, overall sealing performance advantages, or both, in some applications.

The sealing demand allocation among each seal in the multiple-stage sealing arrangement may be further tailored by providing leakage channels 242 to intentionally effect a leakage flow around the preceding seal stage, thereby limiting the severity experienced by the preceding sealing stage. For example, a cross sectional dimension of the leakage channels 242, transverse to a flow direction through the leakage channels 242, may be designed to effect a target pressure drop versus leakage flow relationship through the particular leakage channel 242 and therefore achieve a desired sealing performance distribution across the multi-seal system.

Referring to FIG. 4, the leading edge 450 of the seal element 302 may provide a scraping function, to scrape particles away from the interface between the seal element 302 and the bore 204, such that the particulates may be discharged from the pumping chamber 212 through the outlet port 256 (see FIG. 2). Further, one or more optional circumferential grooves 320 in the seal element 302 may provide a particulate trapping function, so that particulates that flow past the leading edge 450 of the seal element 302 may travel downstream and be captured in the one or more circumferential grooves 320. Moreover, particulates trapped in the circumferential grooves 320 may be ground into particulates of smaller size through reciprocating motion of the piston 206 relative to the bore 204, thereby decreasing the effect the particulates may have on seal life by reducing their size.

Tailoring the leakage flow through the leakage channel 242 may effect a leakage flow between the radially inner surface 310 of the energizer 304 and the radial wall 360 of the land 240 of the piston 206. It will be appreciated that in such an arrangement, the energizer 304 bears against the radial wall 360 of the land 240 through a film of leakage flow therebetween. As a result, the bearing force of the seal element 302 against the bore 204 may be a superposition of combined pressure balanced forces from the leakage flow urging the energizer 304 and seal element 302 toward the bore 204, and structure balanced forces produced by the resilience of the energizer 304 along the radial direction 232.

Referring to FIG. 5, the leading edge 452 of the carrier ring 400 may provide a scraping function, to scrape particles away from the interface between the carrier ring 400 and the bore 204, such that the particulates may be discharged from the pumping chamber 212 through the outlet port 256 (see FIG. 2). Further, one or more optional circumferential grooves 422 in the carrier ring 400 may provide a particulate trapping function, so that particulates that flow past the leading edge 452 of the carrier ring 400 may travel downstream and be captured in the one or more circumferential grooves 422. Moreover, particulates trapped in the circumferential grooves 422 may be ground into particulates of smaller size through reciprocating motion of the piston 206 relative to the bore 204, thereby decreasing the effect the particulates may have on seal life by reducing their size. It will be appreciated that the seal element 302 may contribute further particulate scraping, particulate trapping, and particulate grinding functions, as described with respect to FIG. 4, in addition to those performed by the carrier ring 400 in FIG. 5.

Tailoring the leakage flow through the leakage channel 242 may effect a leakage flow through the leakage chamber 432. As a result, the bearing force of the seal element 302 against the bore 204 may be a superposition of combined pressure balanced forces from the leakage flow urging the carrier ring 400, energizer 304, and seal element 302 toward the bore 204 and structure balanced forces produced by the resilience of the energizer 304 along the radial direction 232.

During some operating conditions of the pump 200, for example during lower pressure rise operation, the seal element 302 may bear against the bore 204 through bias of the radial resilience of the energizer 304, but the pressure force generated in the leakage chamber 432 may not be sufficient to bear the carrier ring 400 against the bore 204. During other operating conditions, for example during higher pressure rise operation, both the seal element 302 and the carrier ring 400 may bear against the bore as a result of the higher pressure in the leakage chamber 432 biasing the carrier ring toward the bore 204 in the radial direction 232.

The carrier ring 400 resists the pressure force generated in the leakage chamber 432 with a resilience in the radial direction 232. According to an aspect of the disclosure, the resilience of the carrier ring 400 in the radial direction 232 is greater than the resilience of the energizer 304 in the radial direction 232.

According to an aspect of the disclosure, the seal element 302 includes a polymer. According to another aspect of the disclosure the seal element 302 includes an ultra-high molecular weight polyethylene (UHMWPE) polymer, a polytetrafluoroethylene (PTFE) polymer, a PTFE polymer filled with a metal, a PTFE polymer filled with carbon fiber, combinations thereof, or any other polymer or polymer composite known in the art for use as a sealing element.

According to an aspect of the disclosure, the energizer 304 is made from a solid polymer. According to another aspect of the disclosure, the energizer 304 is a solid PTFE polymer, which may provide beneficial cold elasticity in some applications.

According to an aspect of the disclosure, the carrier ring 400 is made from a metal, such as stainless steel, a nickel alloy, or other metal known in the art to be suitable for the particular application. According to another aspect of the disclosure, a coefficient of thermal expansion of the housing 202 is the same as a coefficient of thermal expansion of the carrier ring 400.

According to another aspect of the disclosure, a coefficient of thermal expansion of the housing 202 is greater than a coefficient of thermal expansion of the carrier ring 400, such that in cryogenic applications a gap decreases or a bearing force increases between the carrier ring 400 and the bore 204 when the temperatures of the carrier ring 400 and the bore 204 are decreased. As a non-limiting example, the body may be made from an austenitic stainless steel having a coefficient of thermal expansion near 12×10⁻⁶/° C. at an operating temperature of interest, and the carrier ring may be made from a martensitic stainless steel having a coefficient of thermal expansion near 8×10⁻⁶/° C. at an operating temperature of interest. However, persons having skill in the art will appreciate that other materials may be used for the carrier ring 400 and the housing 202 to effect differential thermal expansion upon cooling the pump 200.

It will be appreciated that the optionally removable piston cap 214 may facilitate assembly of the first seal 202 into its corresponding land 240 when any of the seal element 302, the energizer 304, or the carrier ring 400 have a unitary or non-split structure, free from a split or break at a circumferential location or along a circumferential sector.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A seal for a piston of a positive displacement pump, the seal comprising:
an annular seal element, a radially outer surface of the annular seal element defining a longitudinal axis; and
an annular energizer disposed between the annular seal element and the longitudinal axis along a radial direction, the annular energizer having a resilience along the radial direction to bias the annular seal element away from the longitudinal axis along the radial direction, the radial direction being perpendicular to the longitudinal axis,
the radially outer surface of the annular seal element defining at least one circumferential groove about the annular seal element, a concavity of the at least one circumferential groove facing away from the longitudinal axis along the radial direction.

2. The seal of claim 1, wherein the at least one circumferential groove includes a first circumferential groove and a second circumferential groove.

3. The seal of claim 1, wherein the at least one circumferential groove consists of a first circumferential groove and a second circumferential groove.

4. The seal of claim 1, wherein the radially outer surface of the annular seal element is substantially parallel to the longitudinal axis.

5. The seal of claim 4, wherein the radially outer surface of the annular seal element extends from a first axial face of the annular seal element to a second axial face of the annular seal element, and the first axial face of the annular seal element is substantially parallel to the radial direction.

6. The seal of claim 1, wherein the radially outer surface of the annular seal element extends from a first axial face of the annular seal element to a second axial face of the annular seal element, and
wherein an overall length of the annular energizer along the longitudinal axis is less than a distance from the first axial face of the annular seal element to the second axial face of the annular seal element.

7. The seal of claim 2, wherein the annular seal element includes a first seal element disposed adjacent to a second seal element along an axial direction, the axial direction being parallel to the longitudinal axis, and
wherein the first seal element defines the first circumferential groove, and the second seal element defines the second circumferential groove.

8. The seal of claim 3, wherein the first circumferential groove and the second circumferential groove are defined by a unitary structure of the annular seal element.

9. The seal of claim 1, wherein the annular seal element is continuous about a circumference of the annular seal element.

10. The seal of claim 9, wherein the annular energizer is continuous about a circumference of the annular energizer.

11. The seal of claim 1, wherein an outer radial surface of the annular energizer is in contact with an inner radial surface of the annular seal element, the inner radial surface of the annular seal element being opposite the outer radial surface of the annular seal element.

12. The seal of claim 1, wherein the annular seal element includes a polymer.

13. The seal of claim 12, wherein the polymer includes ultra-high molecular weight polyethylene.

14. A seal for a piston of a positive displacement pump, the seal comprising:
an annular seal element, a radially outer surface of the annular seal element defining a longitudinal axis;
an annular energizer disposed between the annular seal element and the longitudinal axis along a radial direction, the annular energizer having a resilience along the radial direction to bias the annular seal element away from the longitudinal axis along the radial direction, the radial direction being perpendicular to the longitudinal axis; and
a carrier ring disposed between the annular energizer and the longitudinal axis along the radial direction, the carrier ring including
an annular base,
a first flange extending radially from the annular base, and
a second flange extending radially from the annular base, the second flange being spaced apart from the first flange along an axial direction, the axial direction being parallel to the longitudinal axis,
the annular seal element being at least partly disposed between the first flange and the second flange of the carrier ring along the axial direction.

15. The seal of claim 14, wherein a radially outer surface of the first flange defines a first circumferential groove of the carrier ring about a circumference of the carrier ring, a concavity of the first circumferential groove of the carrier ring facing away from the longitudinal axis along the radial direction.

16. The seal of claim 15, wherein a radially outer surface of the second flange defines a second circumferential groove of the carrier ring about the circumference of the carrier ring, a concavity of the second circumferential groove of the carrier ring facing away from the longitudinal axis along the radial direction.

17. The seal of claim 15, wherein the radially outer surface of the annular seal element defines at least one circumferential groove about the annular seal element, a concavity of the at least one circumferential groove facing away from the longitudinal axis along the radial direction.

18. A positive displacement pump, comprising:
a housing defining a bore therein;
a piston disposed within the bore and configured for reciprocating translation therein;
a seal disposed about a circumference of the piston, the seal including
an annular seal element, a radially outer surface of the annular seal element defining a longitudinal axis;
an annular energizer disposed between the annular seal element and the longitudinal axis along a radial direction, the annular energizer having a resilience along the radial direction to bias the annular seal element away from the longitudinal axis along the radial direction, the radial direction being perpendicular to the longitudinal axis; and
a carrier ring disposed between the annular energizer and the longitudinal axis along the radial direction, the carrier ring including
an annular base,
a first flange extending radially from the annular base, and
a second flange extending radially from the annular base, the second flange being spaced apart from the first flange along an axial direction, the axial direction being parallel to the longitudinal axis,
the annular seal element being at least partly disposed between the first flange and the second flange of the carrier ring along the axial direction.

19. The positive displacement pump of claim 18, wherein a coefficient of thermal expansion of the housing is greater than a coefficient of thermal expansion of the carrier ring.

20. The positive displacement pump of claim 18, wherein the carrier ring does not bear on the bore of the housing in response to a first fluid pressure, and the carrier ring bears on the bore of the housing in response to a second fluid pressure, the first fluid pressure being less than the second fluid pressure.
